(19) United States
(12) Patent Application Publication
(10) Pub. No.: US 2018/0336498 A1
(43) Pub. Date: Nov. 22, 2018

(54) SEAT CHECK AND SHARING PLATFORM

(71) Applicant: Akber Gilani, Scottdale, GA (US)

(72) Inventor: Akber Gilani, Scottdale, GA (US)

(21) Appl. No.: 15/981,845

(22) Filed: May 16, 2018

Related U.S. Application Data
(60) Provisional application No. 62/507,000, filed on May 16, 2017.

(51) Int. Cl. G06Q 10/02; G06Q 30/06

(52) U.S. Cl. CPC G06Q 10/02; G06Q 30/0207; G06Q 30/0601

(57) ABSTRACT

Disclosed herein is a seat check and sharing platform. The platform may be configured to create, based on data received from a host, a listing for an open seat and publish the listing. Then, the platform may receive search parameters from requestors seeking to request the seat. The platform may filter a plurality of published listings based on the search parameters and display the filtered plurality of listings to requestor. When a requester selects a listing, the platform may display data associated with the selected listing. The offeror of the seat may receive the request and choose to accept the request.

### CROSS REFERENCE TO RELATED APPLICATIONS

This application claims the benefit of priority to U.S. Provisional Patent Application Ser. No. 62/507,000, filed May 16, 2017, which is hereby incorporated herein by reference in its entirety.

### FIELD OF DISCLOSURE

The present disclosure generally relates to systems and methods for sharing seats, for example, open seats at a customer table in dining and entertainment establishments.

### BACKGROUND

Seating availability at businesses can be affected by a number of different factors such as capacity, availability, and demand. For example, it may be difficult to get a table or be seated during peak times at popular restaurants and dining establishments. Generally, a potential customer must wait for a table to open up in order to dine at the restaurant. However, many customers often have open seats at their tables that remain unoccupied for potentially long periods of time. Even though many diners would potentially share their open seats, restaurants will not or cannot offer these open seats to potential diners looking to be seated. This combination of seat availability and table shortage can be frustrating for both businesses and waiting customers. These same issues are also faced by other entertainment establishments or venues, such as nightclubs, concert halls, sporting venues, or other block seating or table-based services. Accordingly, there a remains a need for improved methods and systems for finding and sharing open seats. This need and other needs are met by the various aspects of the present disclosure.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings can contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings can contain text or captions that can explain certain embodiments of the present disclosure. This text is included for illustrative, non-limiting, explanatory purposes of certain embodiments detailed in the present disclosure. In the drawings:

FIG. 1 is a flow chart depicting a method for providing a seat sharing platform in accordance with an exemplary embodiment of the present invention.

FIG. 2 illustrates a user interface (UI) for a seat sharing platform in accordance with an exemplary embodiment of the present invention.

FIG. 3 illustrates a second UI for a seat sharing platform in accordance with an exemplary embodiment of the present invention.

FIG. 4 illustrates a third UI for a seat sharing platform in accordance with an exemplary embodiment of the present invention.

FIG. 5 is a block diagram depicting a computing system for providing embodiments of the seat check and sharing platform in accordance with an exemplary embodiment of the present invention.

### DETAILED DESCRIPTION

As a preliminary matter, it will readily be understood by one having ordinary skill in the relevant art that the present disclosure has broad utility and application. As should be understood, any embodiment can incorporate only one or a plurality of the above-disclosed aspects of the disclosure and can further incorporate only one or a plurality of the above-disclosed features. Furthermore, any embodiment discussed and identified as being “preferred” is considered to be part of a best mode contemplated for carrying out the embodiments of the present disclosure. Other embodiments also can be discussed for additional illustrative purposes in providing a full and enabling disclosure. As should be understood, any embodiment can incorporate only one or a plurality of the above-disclosed aspects of the display and can further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods can be shown and described as being in a sequence or temporal order, the steps of any such processes or methods are not limited to being carried out in any particular sequence or order, absent an indication otherwise. Indeed, the steps in such processes or methods generally can be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure can be described, modifications, adaptations, and other implementations are possible. For example, substitutions, additions, or modifications can be made to the elements illustrated in the drawings, and the methods described herein can be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### A. Platform Overview

Consistent with various embodiments and aspects of the present disclosure, provided herein is a Seat Check and Sharing Platform (hereinafter referred to as the “platform”). This overview is provided to introduce a selection of concepts in a simplified form that are further described below. This overview is not intended to identify key features or essential features of the claimed subject matter. Nor is this overview intended to be used to limit the claimed subject matter's scope.

In various aspects, the seat sharing platform may enable users of the platform (e.g., individuals or organizations) to offer empty or unoccupied seats for use, sale, and/or rent to other users of the platform, for example, and without limitation, at a restaurant. In further aspects, the platform may be used by users to share their seat rights. For example, the users of the seat sharing platform may not actually own the seat they are sharing. In certain embodiments, users may have a license or limited scope of use to the seat. For example, a user may be dining at a certain restaurant and have limited use rights or time frame to use the seats at the table which they are dining at. As a result, the seat sharing platform may be used to allow users to share their licenses (e.g., authorizations, permits, registrations). In this aspect, the seat shared may be a user's rights to use the seat.

In various embodiments of the present disclosure, users may offer or share open seats in exchange for any valuable consideration. The consideration may comprise, for example, an exchange of money, discounts, services and/or goods. In some embodiments, and as will be detailed below, the platform may facilitate at least a portion of the consideration (i.e., money, discounts, services, or goods) to a seat owner, such as, for example, a business, venue, event manager, or restaurant that owns the seat and/or premises where the seat is located. In other embodiments, the platform may facilitate at least a portion of the consideration (i.e., money, discounts, services, or goods) from the seat owner to various users of the platform, for example, a seat offeror and/or seat requester.

In further aspects, the platform may employ a reward system, or a points system similar to a rewards system. The points may, for example, comprise a money-like value and may be used as consideration for seats being shared through the platform. As will be detailed below, users of the platform may purchase points and/or be awarded points for various reasons, including, but not limited to, their active use of the platform. In this way, a requester may use points to, for example, secure an available restaurant seat offered on the platform, while the user offering the seat may receive the points from the user seeking the seat. These points may then be exchanged for monetary value or, for example, be used for other transactions within the platform.

In yet further aspects, the platform may provide incentives or rewards to either or both of the users (i.e., table host and seat guest) to encourage use of the platform. In some aspects, a potential table host may be offered an incentive to make available or otherwise share open seats at their table, such as, for example, during busy periods. In further aspects, the platform may be able to detect or determine tables with open seats and offer incentives to users at these tables. In other aspects, a user looking for open seat may be offered an incentive to select or otherwise request open seats at certain tables in certain, such as, for example, during a restaurant slow period. In further aspects, the platform may be able to detect or determine which tables with open seats and offer incentives to users at these tables.

In some aspects, incentives may be initiated and offered by the platform based on an algorithm, analysis of the platform, data trends, and meeting predetermined criteria. In other aspects, the incentives may be initiated and offered by the venue or restaurant owner. In further aspects, the incentives may comprise, for example, money, free food or drink offers, or discount offers. Accordingly, embodiments of the present disclosure are not limited to solely a single form of consideration in exchange for seat sharing. Rather, many different types of consideration may be used.

In some aspects, the platform may facilitate negotiation between users. For example, in some aspects, the user offering the seat may take requests from potential guests and negotiate with them through an interface of the platform. In other aspects, the user offering the seat may take offers from potential requesters and negotiate with them through an interface of the platform. In various embodiments, though not required, the requests or offers may be in the form of bids in a bidding system. Accordingly, any standard transaction may be facilitated between the offeror of the seat and the requestor of the seat to secure the sharing of the seat.

Moreover, it should be understood that, in many embodiments, the seat shared over the platform may not actually be sold. Instead, the seat may be used or rented for a pre-negotiated period of time, for example, and without limitation, during a meal period. In this way, the seat sharing platform may serve as a platform to license or temporarily share seats from one user to another. As a result, the platform may enable users to make efficient and, in certain scenarios, gainful use of open seats at their table.

The platform may enable, for example, the registration, listing and sharing of available seats for negotiated or pre-arranged durations. Using the platform, users having available seats may create a listing for the open seats. The platform may then be operative to publish the listing to other users. The other users may be, for example, prospective diners at a restaurant browsing through available seat listings on the platform. In exemplary aspects, a first user can be sitting in a restaurant with two empty seats at their table, while a second user can be looking for empty seats at the same restaurant so they can eat at the restaurant without having to wait for a table. In further aspects, the first user can utilize the seat sharing platform to list their two empty seats. In still further aspects, the second user can send a request to the first user requesting one or both of the available seats. In yet further aspects, the first user can review the request to accept or decline. In even further aspects, if the first user accepts the request, the second user can then utilize the empty seats at first user's table without waiting for a table in the restaurant.

The published listing may comprise information relating to the available seats including, but not limited to, the location of the seats, the number of available seats, the configuration of seats, a description of the available seats, a photo of the seats, a mapped location of the seats, dates and time duration of seat availability, and a price for the seat. In other embodiments, the location of the user may be manually provided by the user. In embodiments, the platform may be configured to list the location or name of the property or business associated with the open seats. Some of the information may be provided by a user offering the seat, while other information may be provided by an administrator of the platform. In various embodiments, a portion of the listed information may be retrieved by an automated back-end process performed by the platform.

Platform users who are seeking available seats may browse through the published listings of seats on the platform. To determine the most relevant seat listings to display to the user, the listings may be filtered based on various parameters, such as, and without limitations, a location of the user, number of available seats, duration of availability, or the like. The location of the user may be determined by, for example, input from a user device, such as, for example, a mobile computing device (e.g., a mobile phone, tablet, or laptop), a desktop computing device, or a computing device integrated into an existing system (e.g., on-board computing devices for vehicles) used to access the platform. In some embodiments, the user device may comprise components capable of gathering location information and inputting the location information to the platform. The location gathering components may comprise, but are not limited to, for example, a Global Positioning System, antenna triangulation algorithms, an IP address, or any other means from which the location of the user device may be derived. The platform may be capable of receiving and parsing this information to determine the location of the user.

Having the location of the user, the platform may then be operative to display those listings that are associated with available seats within a predetermined radius of the user. In various embodiments, the radius may be defined by the user and/or set by a default parameter configurable by the user. Still consistent with embodiments of the present disclosure, the seat sharing platform may also enable users to further search the listings by seat configuration, duration of seat availability, seat location or coordinates on the property, user attributes, and/or by cost. In exemplary aspects, a first user sitting in a restaurant listing available seats on the seat share platform can decide how long the listing can remain active. In further aspects, the platform can be configured to show the listing to users looking for available seat within a predetermined radius, for example, 2 miles. In some embodiments, the seat sharing platform may enable location tracking to allow the offeror (e.g., seat host) to track the requester (e.g., seat purchaser) and monitor the real-time location of the requester while in route to the seat. In other embodiments, the seat sharing platform may enable potential requesters to request or place bids on desired seats. The user that registered and listed the seat may receive a notification of the request or bid and process the request as necessary. Moreover, the platform may provide an interface for placing and managing the request (or bidding) system as will be described in greater detail below.

The platform may further comprise an interface for facilitating agreements on the sharing of a seat listed on the platform. The interface will be described in greater detail below. Furthermore, the platform may facilitate payment transactions between the seat offeror and seat requester. In other embodiments, the platform may enable the seat offeror and seat requester to arrange for payment amongst themselves.

In other exemplary aspects, the present disclosure also provides computer-readable non-transitory storage medium comprising a set of instructions which when executed perform a disclosed method. In still other exemplary aspects, the present disclosure also provides devices and systems configured to execute one or more steps of the disclosed methods.

In various aspects, the disclosed seat sharing platform can advantageously save users time by reducing or eliminating waiting for restaurant tables to open up. In further aspects, the platform can advantageously provide on-demand, instant reservations that can fill open seats at occupied tables that would in other cases remain empty.

Though the following disclosure describes embodiments of disclosure in the context of sharing open restaurant seats, the disclosure is not limited to restaurant seat sharing alone. Rather, restaurant seat sharing is disclosed as one example of seat sharing facilitated in accordance to the various embodiments of the present disclosure.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### B. Platform Configuration

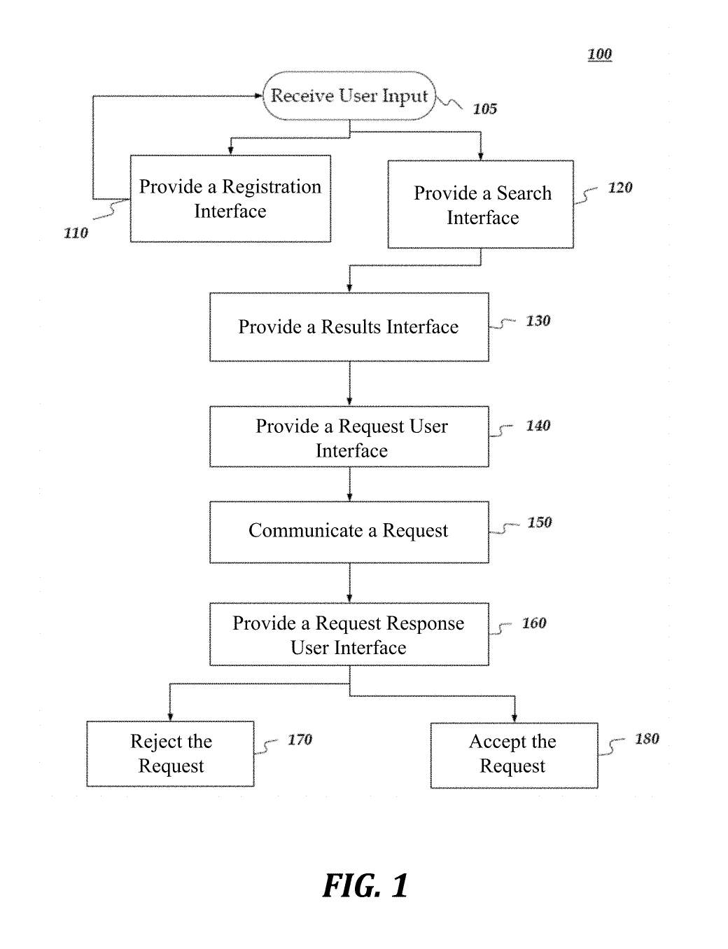

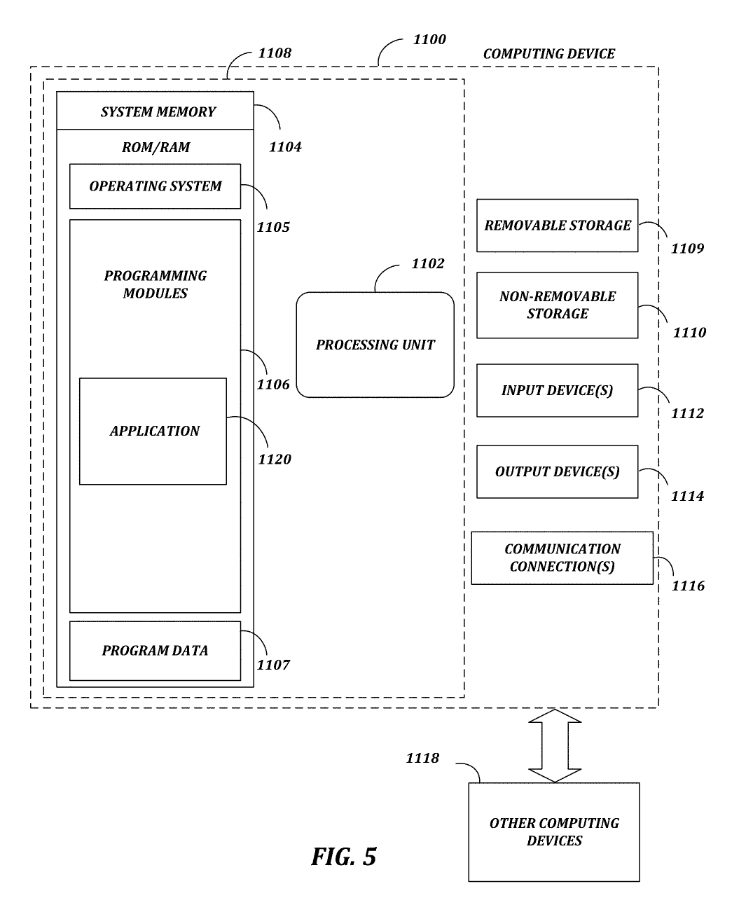

In one aspect, FIG. 1 is a flow chart setting forth the general stages involved in a method 100 consistent with an embodiment of the disclosure for providing a seat check and sharing platform. Method 100 may be implemented using a computing device 1100 as described in more detail below with respect to FIG. 5. The computing device may comprise a seat sharing platform application installed therein. The seat sharing application, in turn, may be operative to implement at least one of the stages described by method 100.

Although method 100 has been described to be performed by a computing device 1100, it should be understood that, in some embodiments, different operations may be performed by different networked elements in operative communication with computing device 1100. For example, a server in communication with computing device 1100 may be employed in the performance of some or all of the stages in method 100. Moreover, in some embodiments, the server may be configured much like computing device 1100 as described in FIG. 5.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 100 will be described in greater detail below.

The user may first register and login to the platform using manually inputted credentials. The user may further tie any registration and login to a social network to which the user belongs. This includes, but is not limited to, Facebook, Twitter, LinkedIn, Google+, and the like. In this way, a user profile may be created for the user consistent with an existing social network profile. Moreover, having tied the user profile to a social network, the platform may be enabled to share the user's activity on the platform to the social network.

Method 100 may begin at stage 105, wherein the platform awaits a user input. The user input may specify whether the user would like to use the platform to list an empty seat or to search for an available seat. In further aspects, the platform can comprise at least one user interface for receiving the user input. In still further aspects, the interface can provide the user with a first option to list empty seats to the platform and a second option to find available seats or tables through the platform.

From stage 105, method 100 may enter stage 110 when the input received corresponds to a request to list an available seat from a first user (e.g., first option). Alternatively, method 100 may enter stage 120 when the input received corresponds to a request to find an empty seat from a second user (e.g., selection of second option).

Upon entering stage 110, the seat sharing platform may present the first user with a restaurant seat listing registration user interface. The registration user interface may be comprised of various input elements, such as text boxes, drop down menus, radio buttons, check boxes, buttons, etc. Consistent with embodiments of the disclosure, the listing creation user interface may enable the first user to input public information. Public information may comprise, but not be limited to, for example, information relating to the empty seat to be listed, including but not limited to, the name of the venue or restaurant, the address of the seat, the times and dates/days the seat is available, a picture of the seat, request types that are acceptable to utilize the seat, a minimum acceptable bid on the seat, and a written description of the seat. In various embodiments, and as mentioned above, the location data may be automatically populated into the search user interface based on location information derived from a user device associated with the first user.

In various aspects, the interface may further comprise private information. Private information may comprise, but not be limited to, for example, instructions or restrictions for using the seat, and the contact information of the first user.

The first user may designate some of these inputs to be listed publicly in the open seat listing, while other inputs may only be viewable by other users upon special designation of the first user. In further aspects, the platform may comprise a listing creation user interface that may provide a button to submit the seat listing to the platform. After the first user elects to submit the listing, a record of the seat listing may be created and stored in an open seat listing database, at which point method 100 may, in some embodiments, return to stage 105.

Upon entering stage 120, the seat sharing platform may present the second user with an open seat listing search user interface. In further aspects, the seat listing search user interface may enable a second user to input parameters to search the seat listings database. Such parameters may comprise, but are not limited to, for example, number of available seats at a table, location data representing the desired location of a seat or restaurant, the times and duration of desired usage of a seat, and/or a desired purchase price of a seat. All of these elements need not be present in search user interface. Rather, any combination of elements may be used. The location data may be comprised of, but not limited to, for example, addresses, GPS coordinates, zip codes, landmarks, town names, etc. In various embodiments, and as mentioned above, the location data may be automatically populated into the search user interface based on location information derived from a user device associated with the second user.

Consistent with embodiments of the disclosure, the search interface may provide for the selection from a timer to enable the second user (e.g., requester) to select a desired time period or range of time periods. In some aspects, the desired purchase price of a listed seat may be designated as a maximum price the potential requester is willing to pay. Furthermore, the seat listing search user interface may provide for a button enabling the second user to initiate a search of the seat listings database, based on the input of any number of the inputted search parameters.

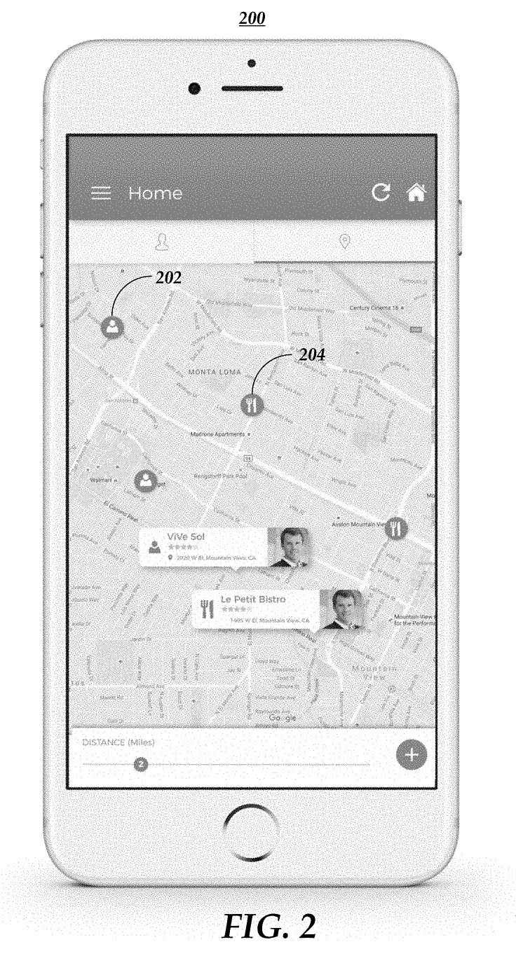

Method 100 may advance to stage 130 from stage 120 in response to the execution of a search by the second user. Upon entering stage 130, the seat sharing platform may present the second user with a seat listing results user interface. In further aspects, the seat results user interface may display results in the form of a list of seat records, wherein each record may correspond to an open seat or table that has been listed as available. The listed results may be based on the search parameters (e.g., number of open seats, location data, time duration, etc.). In an exemplary embodiment, FIG. 2 illustrates a seat listing results user interface 200 showing nearby open seat listings 202 and open table listings 204 on a map.

Consistent with embodiments of the present disclosure, a seat listing record may display information relating to the seat (or table) listing including, but not limited to, the number of open seats, seat configuration, the address of the seat or table, a map indicating the location of the seat or table, time duration, information identifying the user offering the seat, and ratings data associated with the offeror. In various embodiments, certain listings may receive a higher ranking and/or promotion based on various factors, including, but not limited to, relevancy to the search parameters, a promotion, or the user ratings data.

The promotions and user ratings data may be based on supplemental payments for the listing and/or user reviews. The results user interface may provide the second user with an option to filter or sort the results based on various factors including, but not limited to, user, number of open seats, distance, duration, and/or reviews. Each of the displayed results may be selectable via a selectable element displayed with the listing.

From stage 130, method 100 may advance to stage 140 in response to the selection of a particular seat listing record by the second user. Upon entering stage 140, the seat sharing platform may present the second user with a user request (or bid) interface.

The request or bid interface may display seat data provided by the first user during stage 110. In addition, the request or bid interface may comprise a duration selection tool such as, for example, a timer, to allow the second user to view the availability of the seat and to select a minimum duration which the second user would like to share the seat.

In further aspects, the request or bid interface may also comprise an input field in which the second user may provide information to the first user. The information may comprise, but not be limited to, for example, a brief description of the second user and/or comments, questions, or special requests the second user may have. The information inputted by the second user may, in turn, be provided to the first user for review.

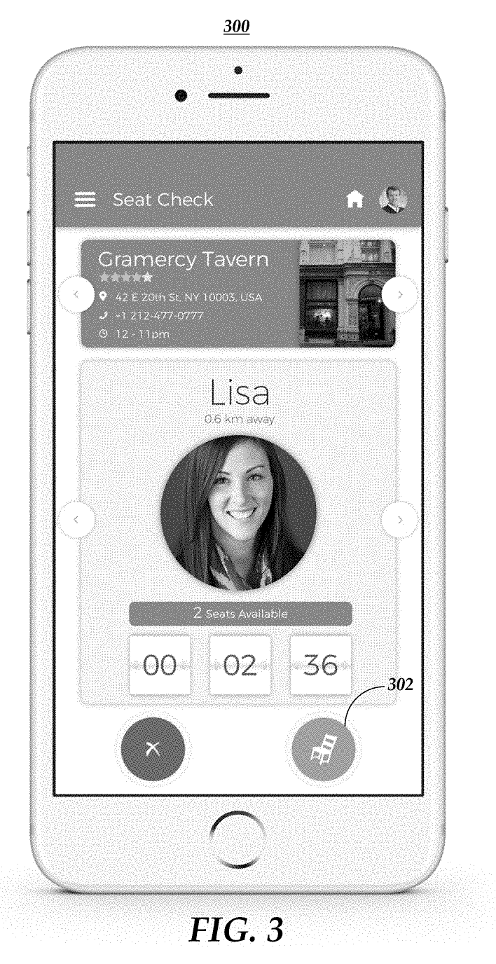

The request or bid interface may further provide an input field for enabling the second user to request or place a bid on the seat. For example, in some embodiments, the second user may select a seat listing on which he would like to request, and, in other embodiments, may also include an input field for an amount the second user is willing to bid. In various embodiments, the second user may not need to bid on the seat. Rather, the first user (e.g., offeror) may not require a fee or may set a fixed price for the seat. In turn, the user interface may provide the fixed price upon receiving the inputs from the second user (e.g., requester). As such, the request (or bid) user interface may still provide the input field for enabling the second user to place a bid on the seat, but such input field may be optional, acceptable only at the offeror's discretion. The request user interface may provide a button enabling the second user to submit the request to the platform. In an exemplary embodiment, FIG. 3 illustrates a seat listing user interface 300 showing an open seat listing record from an offeror with a request button 302.

Method 100 may proceed to stage 150 from stage 140 upon the submission of, for example, a request or bid by the second user. In stage 150, the seat sharing platform may facilitate communication of the request or bid from the second user to the first user. This may be accomplished through any form of electronic communication, including but not limited to, notifying the first user of the request or bid by telephone, text message, email, or messaging capabilities that may be provided within, or operatively associated with, the platform. For example, the platform may present the first user with an inbox user interface.

Said inbox user interface may provide, for example, a listing of messages sent by other users. The listing of messages may provide message information such as, but not limited to, the username of the sender of the message, the subject of the message, and a preview of the message. In some embodiments, a button may be provided with the list of messages which, upon selection, enables the first user to select a particular message for further viewing. The messages may comprise, for example, request or bid information as well as any input the second user submitted along with the request or bid information. Though the inbox is described in the context of the first user throughout this disclosure, embodiments of the present disclosure may provide a similar inbox user interface to the second user.

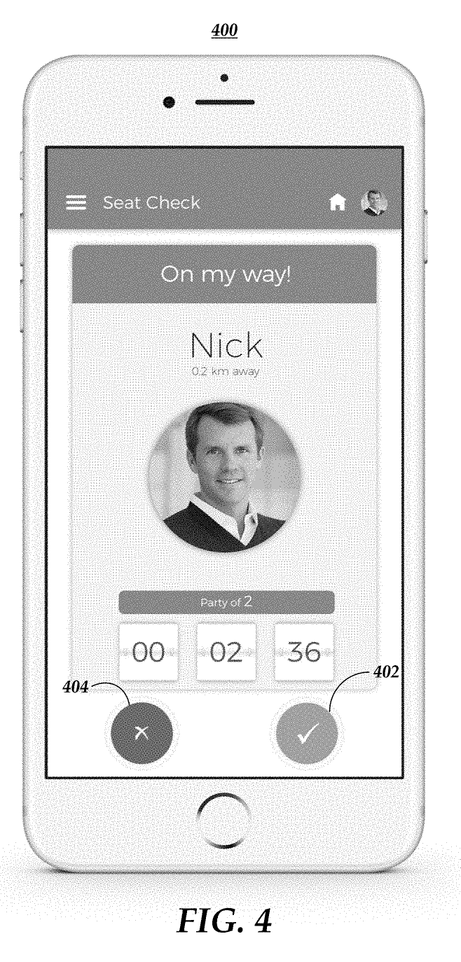

Method 100 may enter stage 160 from stage 150 in response to the selection of a message for further viewing by the first user. Upon entering stage 160, the seat sharing platform may present the first user with a notification or message user interface. In further aspects, the message user interface may provide a representation of request (i.e., bid or offer) parameters submitted by the second user in the request or bid user interface provided in stage 140, including, but not limited to, bid amount, duration of desired use of seat, information identifying the seat that is the subject of the request or bid, information identifying the identity of the second user, and a message composed by the second user in association with the request or bid. Said message user interface may further provide buttons allowing a first user to accept the request, reject the request or reply to the request with a message or, for example, counter request. In an exemplary embodiment, FIG. 4 illustrates a message user interface 400 showing a request from a second user for the open seats along with an accept button 402 and a reject button 404.

Method 100 may advance to stage 170 upon receiving a selection from the first user to reject the request. Upon entering stage 170, the platform may discard the request provided by the second user. In various other embodiments, the platform may be designed to retain the request data provided by the second user in order to enable the second user to revise the request. The platform may further be operative to notify the second user via, for example, the inbox user interface or any other suitable form of communication, that the request was rejected.

Alternatively, method 100 may advance to stage 180 in response to an acceptance of the request by the first user. Upon entering stage 180, the platform may notify the second user that the request was accepted by the first user. In some embodiments, the platform may then facilitate a payment from the second user to the first user using conventional payment processing technology available to one of ordinary skill in the art.

The seat sharing platform may create and store a record of the seat booking and display the record in an overview user interface. Said overview user interface may provide user specific data, such as, but not limited to, username, password, contact information, records of open seats listed by the user and records of seats booked by the user.

Furthermore, said overview user interface may provide buttons including, but not limited to, enabling a user to edit user information, edit details of listed seats, view booking history of listed seats, and provide reviews of booked seats. Selection of one of these buttons may present a user with an account summary user interface. Said account summary user interface may display information related to a particular seat, for example, data on the number of requests received and accepted, reviews of the user, etc.

Consistent with embodiments of the disclosure, the platform may be operative to track a location of the second user (e.g., requester). The tracked location may be provided, via the platform, to the first user (e.g., offeror or table host) when the first user has accepted the request or bid of the requester. In various embodiments, location tracking may be requested by the offeror and subsequently enabled by the requester when the requester is within a predetermined radius of the seat. In some aspects, location tracking may be enabled upon acceptance of the request by the offeror. In this way, the offeror may be enabled to track the requester and monitor the real-time location of the second user while in route to the seat.

Still consistent with embodiments of the disclosure, the requester may be able to confirm or check-in via the platform once the requester has occupied the offeror's seat. A confirmation notification may be provided to the offeror. In this way, the offeror may be able to confirm that the seat is occupied by the correct user. The notification may be posted to an offeror's and/or requester's social network, along with a customized message from the offeror and/or requester. The social network may be a social network tied to the offeror's and/or requester's profile within the platform.

In various embodiments, the check-in may be mandatory and/or automatically submitted to the platform upon a detection that the requester is within the premises of the offeror's seat. For example, the location tracking elements of the requester's device may be monitored by the platform. Once the platform detects that the requester is within the premises of the seat, the platform may, for example, notify the offeror.

Still consistent with embodiments of the present disclosure, a system may be provided for performing a method for collecting and managing information about available resources. The system may be further operative to perform a method for distributing those resources between qualified users on a computer social network. The system may comprise a memory storage and a processing unit coupled to the memory storage. Accordingly, FIG. 5 may, in some embodiments, describe the system as computing device 1100.

The processing unit may be configured to execute a set of instructions stored on the memory storage. The set of instructions may comprise, for example, the seat sharing platform and/or application thereof. In this way, the processing unit may be configured to, for example, store a plurality of data provided by registered legitimate owners of resources to a central database. Various checks may be performed to determine the legitimacy of property (e.g., a resource) ownership, although they are not necessary in some embodiments. The data stored may include, but not be limited to, for example, resource properties, terms of using the resource, and any special conditions for resources availability.

The processing unit may be further configured to, for example, enable registered potential consumers of those resources to perform customized search and display information about up-to-date available resources. The processing unit may then be configured to monitor decisions of registered potential consumers to acquire at least some of the resources identified during a customized search; and request and obtain from registered potential consumers explicit agreement to comply with the terms of use by registered legitimate owners of resources.

In accordance to embodiments of the present disclosure, compliance with the requirements defined by the registered legitimate owners of resources may be verified. Upon verification, the potential consumers may be granted rights to use available resources. Moreover, embodiments of the present disclosure may arbitrate registered potential consumers' requests to guarantee non-over-allocating assignment of available resources. In turn, already allocated resources may be prohibited from being searched and displayed during subsequent searches. Finally, various embodiments may be operative to collect information about the registered consumer who was granted the right to use specific resource. The collected information may be, optionally, provided to the registered legitimate owner of the resource.

### C. Platform Architecture

In various aspects, the platform of the present disclosure may be embodied as, for example, but not be limited to, a website, a web application, a desktop application, and a mobile application compatible with a computing device. Moreover, the platform may be hosted on a centralized server, such as, for example, a cloud computing service. Although method 100 has been described to be performed by a computing device 1100, it should be understood that, in some embodiments, different operations may be performed by different networked elements in operative communication with computing device 1100.

FIG. 5 is a block diagram of a system including computing device 1100. Consistent with an embodiment of the disclosure, the aforementioned memory storage and processing unit may be implemented in a computing device, such as computing device 1100 of FIG. 5. Any suitable combination of hardware, software, or firmware may be used to implement the memory storage and processing unit. For example, the memory storage and processing unit may be implemented with computing device 1100 or any of other computing devices 1118, in combination with computing device 1100. The aforementioned system, device, and processors are examples and other systems, devices, and processors may comprise the aforementioned memory storage and processing unit, consistent with embodiments of the disclosure.

With reference to FIG. 5, a system consistent with an embodiment of the disclosure may include a computing device, such as computing device 1100. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a program data 1107. Operating system 1105, for example, may be suitable for controlling computing device 1100's operation. In one embodiment, programming modules 1106 may include seat sharing application 1120. Furthermore, embodiments of the disclosure may be practiced in conjunction with a graphics library, other operating systems, or any other application program and is not limited to any particular application or system. This basic configuration is illustrated in FIG. 5 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 5 by a removable storage 1109 and a non-removable storage 1110. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1104, including operating system 1105. While executing on processing unit 1102, programming modules 1106 (e.g., seat sharing application 1120) may perform processes including, for example, one or more method 100's stages as described above. The aforementioned process is an example, and processing unit 1102 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. Insofar as the description above and the accompanying drawings disclose any additional subject matter that is not within the scope of the claims below, the disclosures are not dedicated to the public, and the right to file one or more applications to claims relating to such additional disclosures is reserved.

What is claimed:

1. A method for sharing an open seat, comprising:
receiving, by a system having at least one processor, a first set of inputs from a first user, the first set of inputs comprising information associated with at least one of the following: a number of at least one open seat, a location of the at least one open seat, a time duration the at least one open seat is available, and a cost for occupying the at least one open seat within the available time;
creating, by the system, based on the first set of inputs, a listing for the at least one open seat;
publishing, by the system, the listing in a first user interface, the first user interface comprising a plurality of listings;
receiving, by the system, a second set of inputs from a second user, the second set of inputs comprising at least one of the following: a number of desired seats, an approximate location, and a duration of time;
filtering the plurality of listings based on the second set of inputs;
displaying, in the first user interface, the filtered plurality of listings to the second user;
receiving, by the system, from the second user, a selection of a listing from the plurality of listings;
providing, by the system, a second user interface to the second user, the second user interface being operative to:
display seat data associated with the selected listing from the plurality of listings, and
enable the second user to request use of the at least one open seat;
receiving, by the system, a request to use the at least one open seat from the second user;
conveying, by the system, the request to use the at least one open seat to the first user;
receiving, by the system, an acceptance of the request from the first user; and
facilitating, by the system, a financial transaction between two users.

2. The method of claim 1, wherein facilitating the financial transaction between two users comprises facilitating a financial transaction between the first user and the second user.

3. The method of claim 1, wherein facilitating the financial transaction between two users comprises facilitating a financial transaction between the first user or the second user and a third selected from at least one of: a business owner associated with the open seats, venue owner associated with the open seats, and restaurant owner associated with the open seats.

4. The method of claim 1, further comprising tracking, by the system, a location of the second user.

5. The method of claim 4, further comprising providing, by the system, the tracked location of the second user to the first user upon acceptance of the request by the first user.

6. The method of claim 1, wherein displaying, in the first user interface, the filtered plurality of listings to the second user comprises enabling the second user to sort the filtered plurality of listings based on at least one of the following: a distance, a user, a venue associated with each listing, and number of open seats associated with each listing.

7. The method of claim 3, further comprising conveying, by the system, an incentive to the first user in exchange for submitting the first set of inputs used to create the listing.

8. The method of claim 3, further comprising conveying, by the system, an incentive to the second user in exchange for submitting the request; wherein the request is to use a predetermined open seat from among the plurality of listings.

9. The method of claim 7, wherein conveying the incentive to the first user is initiated by the third user.

10. The method of claim 6, wherein the at least one open seat is from among a plurality of seats associated with a table in the venue; and wherein at least one of the plurality of seats is occupied by the first user.

11. A computer-readable non-transitory storage medium having a set of computer-accessible instructions which when executed, cause at least one processor to perform operations comprising:
receiving a first set of inputs comprising information associated with a number of at least one open seat from among a plurality of seats associated with a table with at least one occupied seat, a location of the at least one open seat, and a time duration the at least one open seat is available;
creating a seat listing for the at least one open seat based on the first set of inputs;
publishing the seat listing among a plurality of seat listings;
receiving a second set of inputs comprising at least one of the following: a number of desired seats, an approximate location, and a duration of time;
displaying a filtered plurality of listings based on the second set of inputs;
offering an incentive for submitting a seat request to use at least one open seat of a predetermined seat listing from among the plurality of listings;
receiving a seat request to use at least one open seat from the of a seat listing from the plurality of listings; and
conveying details for use of the at least one open seat.

12. The medium of claim 11, wherein the operations further comprise offering an incentive receiving a seat request to use at least one open seat of a predetermined seat listing from among the plurality of listings; and conveying an incentive upon receiving a seat request to use at least one open seat from the predetermined seat listing.

13. The medium of claim 11, wherein the operations further comprise offering an incentive for creating a seat listing for a predetermined location; and conveying the incentive upon creating a seat listing for the predetermined location.

14. The medium of claim 13, wherein offering of the incentive is prior to receiving the first set of inputs; and wherein the first set of inputs comprises location information associated with the predetermined location.

15. A system, comprising:
at least one memory having computer-accessible instructions; and
at least one processor functionally coupled to the at least one memory and configured by at least a portion of the computer-accessible instructions to:
receive a first set of inputs comprising information associated with a number of at least one open seat from among a plurality of seats associated with a table having at least one occupied seat, a venue location of the at least one open seat, at least one of: a time duration the at least one open seat is available, and a cost for occupying the at least one open seat within the available time;
create a seat listing for the at least one open seat based on the first set of inputs;
publish the seat listing among a plurality of seat listings and table listings;
display a filtered plurality of listings from the plurality of seat listings and table listings based on one or more filters comprising at least one of the following: listing type, a number of desired seats, an approximate location, and a duration of time;
receive a request from a requester to use a seat listing from the filtered plurality of listings;
convey the request to a listing owner;
receive an acceptance of the request from the listing owner; and
issue compensation to the listing owner upon acceptance of the request.

16. The system of claim 15, wherein the at least one processor is further configured to convey the tracked location of the requester to the listing owner upon acceptance of the request.

17. The system of claim 15, wherein the at least one processor is further configured to issue the compensation from the requester to the listing owner.

18. The system of claim 15, wherein the at least one processor is further configured to issue the compensation to the listing owner from at least one of: an owner associated with the venue location and a business associated with the venue location.

19. The system of claim 17, wherein the compensation comprises at least one of money, and reward points.

20. The system of claim 18, wherein the compensation comprises at least one of free goods or services associated with the business or owner.
